(19) United States
(12) Patent Application Publication
(10) Pub. No.: US 2012/0091141 A1
(43) Pub. Date: Apr. 19, 2012

(54) Retro-Fit Quick-Release Sealing Device

(76) Inventor: Darvin Thielbar, Gainesville, GA (US)

(21) Appl. No.: 13/078,062

(22) Filed: Apr. 1, 2011

Related U.S. Application Data
(60) Provisional application No. 61/392,511, filed on Oct. 13, 2010.

(51) Int. Cl. B65D 51/00; B23P 23/00

(52) U.S. Cl. 220/361; 29/401.1

(57) ABSTRACT

A sealing device having a quick-release cover is disclosed for use on ports of pressure vessels, pipe-line access ports and man-ways. In particular, the sealing device may be used to retro-fit a blind flange. The sealing device has a generally circular flange that has a base and a raised neck. The base comprises a plurality of spaced apart apertures with each aperture for receiving an attachment element, such as a bolt or threaded element. The raised neck may be generally cylindrical. The sealing device further comprises a generally cylindrical hub that extends from the raised neck of the generally cylindrical flange. The sealing device has a quick-release cover for sealing a first end of the generally cylindrical hub. The base comprises a base surface substantially perpendicular to a longitudinal axis of said raised neck.

### CROSS REFERENCE TO RELATED APPLICATIONS

This application claims the benefit of the filing date of U.S. Provisional Application No. 61/392,511, filed Oct. 13, 2010.

### INCORPORATION BY REFERENCE

The entire disclosure of U.S. Provisional Application No. 61/392,511, filed Oct. 13, 2010, is incorporated herein by reference.

### FIELD OF THE DISCLOSURE

This disclosure relates to the field of sealing devices on ports of pressure vessels, filters, mixing tanks, filter-separators/coalescers, strainers, scrubbers, pipe-line access ports and man-ways, and in particular retro-fitting blind flanges on fabricated pressure vessels and filter vessels.

### BACKGROUND

In pressure vessel applications, a wide variety of removable enclosures are employed to seal manholes and other access openings. Often, merely a blind flange is used to seal the point of access. However, the blind flange can be cumbersome and time consuming to install and remove because of the large number of attachment bolts the end user is required to manipulate.

In many instances, it is desired that the closure be capable of being manipulated quickly, easily and with minimal manpower. Quick-open closures expedite the user gaining access to the interior of the pressure vessel or pipe-line as well as reduce the manpower required. Currently, a quick-open closure is installed during the fabrication process of the pressure vessel. It is desirable that installation of a quick-open closure occur when the pressure vessel is being manufactured. This is because during the manufacturing process, a welder certified to the particular welding code used for manufacture is required to install the quick-open closure. For the pressure vessel to meet the required welding code (i.e. Section VIII, Division 1 of the Boiler and Pressure Vessel Code, maintained by the American Society of Mechanical Engineers (ASME)), there are many requirements such as: (1) material traceability, (2) Welder Certification and Qualification, (3) Quality Control and Inspection, (4) X-Ray and Ultrasonic Testing, (5) Testing for fractures within the welds, (6) Pressure testing, validation and documentation filed under ASME guidelines. Adherence to these guidelines can be extremely costly. These same requirements must be followed for any modification or repair to the vessel after the initial manufacture and inspection date. Thus, there is a tremendous incentive to have the quick-open closure installed on the pressure vessel while the pressure vessel is being fabricated.

However, an entire fleet of pressure vessels are in the field and were fabricated prior to the development of quick-open closures, or failed to have the quick-open closure installed during fabrication. Currently, if an owner desires to add a quick open closure to an existing pressure vessel, mixing tank or access port, the modifications are required to follow the ASME Boiler Pressure Vessel Code, making them cost prohibitive. Such modifications are cost prohibitive because, for example, any pressure vessel that is designed to operate under pressure or vacuum of greater than 75 PSI, must be built to the ASME Code, which requires that the vessel to be manufactured, tested and certified by an independent ASME Code inspector. Each vessel that is inspected and certified is code stamped with its own individual serial number. Whenever any modifications to the integrity of the vessel are made, such as cutting and welding within the pressure retaining area, the entire vessel must be re-tested, inspected, certified and code stamped “R” for repair. This entire process, while being cost prohibitive by itself, would be impractical for most production facilities to accommodate due to the lost labor production as a result of the unit being inoperable.

### SUMMARY

In accordance with one aspect of the present disclosure, a sealing device is disclosed. According to two embodiments, the sealing device comprises either a t-bolt quick-release closure or a double-bolt quick release closure. The sealing device further comprises a generally circular flange having a base and a generally cylindrical raised neck. The base may comprise a plurality of spaced apart apertures with each aperture for receiving an attachment element, such as a bolt or threaded element. The sealing device further comprises a generally cylindrical hub that extends from the raised neck of the generally cylindrical flange. The quick-release cover seals a first end of the generally cylindrical hub. The base comprises a base surface substantially perpendicular to a longitudinal axis of the raised neck.

In some embodiments, the flange and the hub may be fabricated as two separate components and mechanically connected at an interface between a receiving surface of the raised neck and a second end of the generally cylindrical hub. The mechanical connection may be a welded connection.

Another aspect of the disclosure is a method of retrofitting a blind flange on a port of a pressure vessel with a sealing device having a quick-release cover. The method may comprise at least the steps of:

(a) fabricating a sealing device as disclosed herein;

(b) preparing a pressure vessel flange to receive the sealing device;

(c) attaching the sealing device to the pressure vessel flange using a plurality of attachment elements.

The sealing device is sized according to a pressure rating of the pressure vessel and a size of the pressure vessel flange. The plurality of attachment elements may at least include bolts.

This disclosure resolves issues of cost and production down time, since it does not require any modifications to be made to the existing pressure vessel. The sealing device of the present disclosure, sometimes also referred to herein as the retro fit quick release closure, is an aftermarket component that is manufactured under controlled conditions and follows the requirements of the ASME Boiler Pressure Code for sealing components. According to example embodiments, sealing devices according to the present disclosures are designed for operating conditions of 75 PSI-2500 PSI and access openings of 8″-72″. The retro fit quick release closure can be installed on an existing pressure vessel by removing and replacing the current blind flange with the retro fit quick release closure that has been manufactured for that vessel's operating conditions. This adaptation of the retro fit quick release closure can be performed in minutes and accomplished by the same operator, with standard hand tools, that maintains the vessel on a daily basis. Furthermore, since no modifications were made to the integrity of the vessel (i.e. no cutting or welding) was performed; it will not be required to be ASME inspected and re-stamped saving the owner/operator significant time, expense and lost production.

Those skilled in the art will appreciate the above stated features and benefits of the device of this disclosure by reading the following detailed description of the embodiments with reference to the accompanying drawing figures. It is within the scope of the present disclosure that the above-discussed features be provided both individually and in various combinations.

### DETAILED DESCRIPTION OF THE FIGURES

The present disclosure is now described with respect to the embodiments seen in following drawings. According to common practice, the various features of the drawings discussed below are not necessarily drawn to scale. Dimensions of various features and elements in the drawings may be expanded or reduced to illustrate more clearly the embodiments of the disclosure.

FIG. 1 is a side view of a sealing device having a quick-release cover according to a first embodiment of the present disclosure.

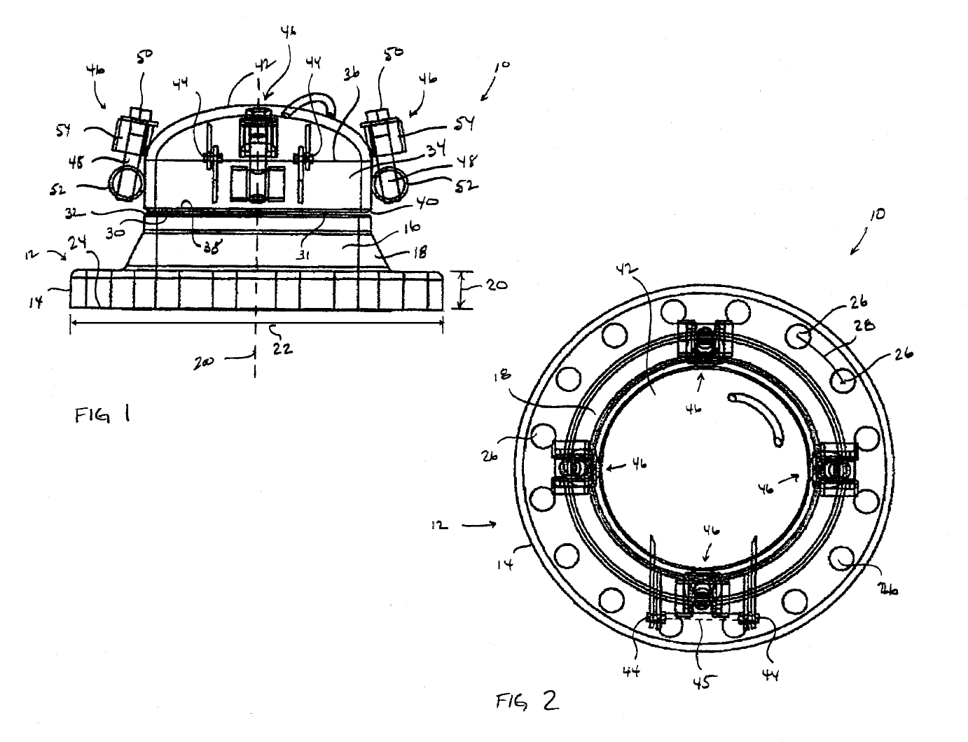

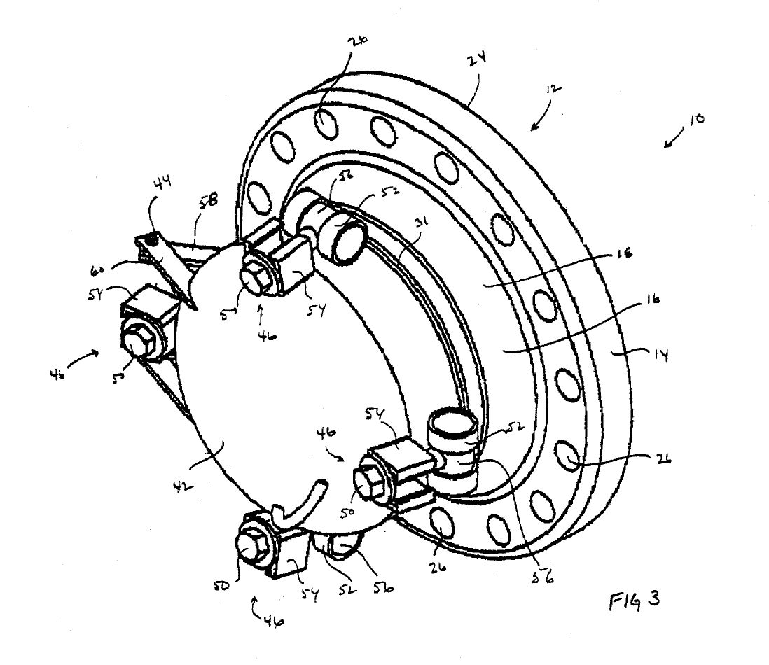

FIG. 2 is a top view of the sealing device as disclosed in FIG. 1.

FIG. 3 is a perspective view of the sealing device as disclosed in FIG. 1.

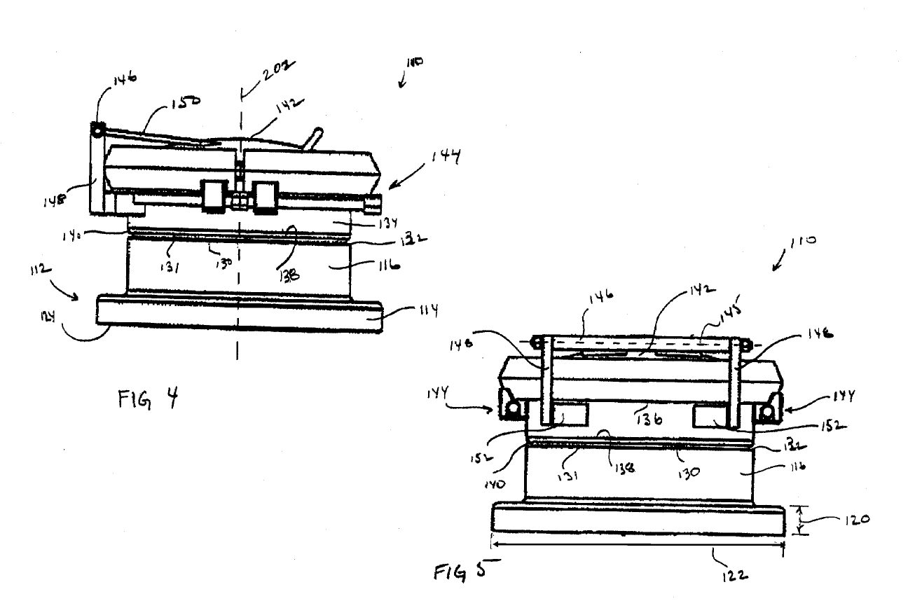

FIG. 4 is a side view of a second embodiment of a sealing device having a quick-release closure according to the present disclosure.

FIG. 5 is a rear view of the sealing device according to FIG. 4.

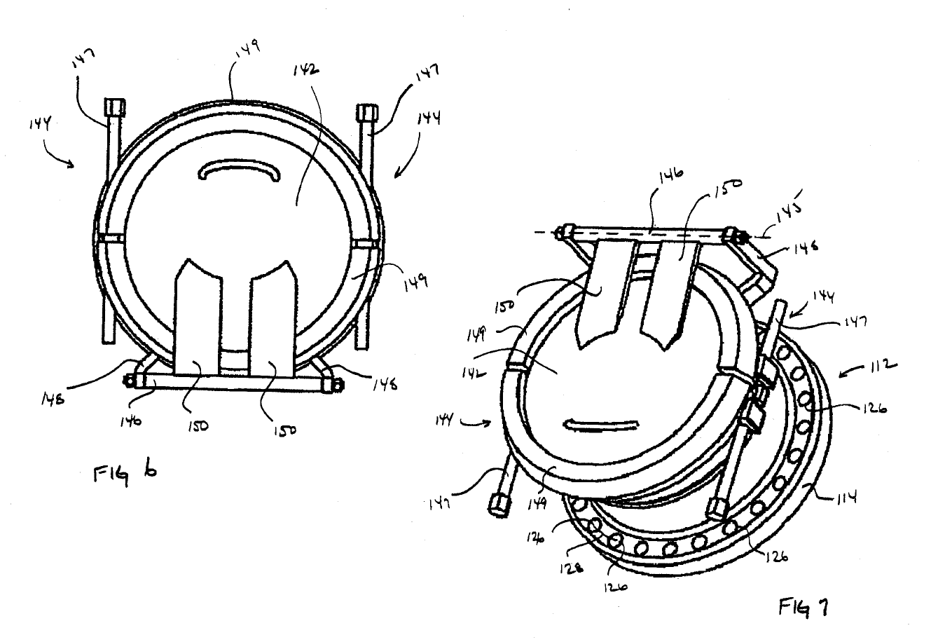

FIG. 6 is a top view of the sealing device according to FIG. 4.

FIG. 7 is a perspective view of the sealing device according to FIG. 4.

### DETAILED DESCRIPTION OF THE DISCLOSURE

While the present invention will be described fully hereinafter with reference to the accompanying drawings, in which particular embodiments are shown, it is to be understood at the outset that persons skilled in the art may modify the invention herein described while still achieving the desired result of this invention. Accordingly, the description which follows is to be understood as a broad informative disclosure directed to persons skilled in the appropriate arts and not as limitations of the present invention.

As required, exemplary embodiments of the present invention are disclosed herein. These embodiments are meant to be examples of various ways of implementing the invention and it will be understood that the invention may be embodied in alternative forms. Therefore, specific structural and functional details disclosed herein are not to be interpreted as limiting, but merely as a basis for the claims and as a representative basis for teaching one skilled in the art to variously employ the present invention.

For purposes of teaching and not limitation, the exemplary embodiments of the quick-release sealing device as disclosed herein are discussed mainly in the context of use relating to pressure vessel technologies.

Reference will now be made to the annexed drawing figures, wherein like reference numerals indicate like parts throughout the several views. FIGS. 1, 2 and 3 illustrate a first embodiment of a sealing device 10 having a quick-release cover that may be used in pressure vessel applications as disclosed herein. The term “quick-release” used throughout this disclosure will be understood by one of skill in the art to mean that a user may articulate the sealing device 10 from an open position to a closed position, or from the closed position to the open position, more efficiently and in a more timely manner than a conventional blind flange which is traditionally used in a pressure vessel or pipe line application. This is because there are fewer attachment elements, or quick-release cover attachment elements, required to open and/or close the sealing device and gain access to an interior of the pressure vessel. In some instances, as few as 2 or 6 quick-release cover attachment elements (e.g. bolts) may require articulation to open or close a 75 PSI 26″ diameter quick-release cover. On the other hand, a standard 75 PSI 26″ blind flange has 36 to be removed to gain access to the interior of the pressure vessel. A blind flange may be a flat plate, generally fabricated from steel, attached to a pressure vessel flange, or flange port, by a plurality of flat plate cover attachment elements, such as bolts. The quick-release sealing device 10 is preferably configured to retro-fit an existing sealing cover, or flat plate cover, of a port of a pressure vessel where a pressure vessel flange exists prior to installation. In general, depending on the application (i.e., a pressure vessel exposed to a high internal or external pressure), the size of the pressure vessel flange will be of a standard geometry, which may include, for example, a standard flange diameter, thickness and number of apertures.

Refer to FIGS. 1 through 3, which show the sealing device 10 from several different perspectives including a side view, a top view and a perspective view respectively. The sealing device 10 may comprise a generally circular flange 12 configured to interface with the pressure vessel flange (not shown) of the pressure vessel. The flange 12 may have a generally circular base 14. The generally circular base 14 provides a point of attachment to the pressure vessel flange as well as an interface to the pressure vessel flange. The flange 12 may also include a raised neck 16, which extends away from the generally circular base 14 and in a direction parallel with a longitudinal axis 200. The longitudinal axis 200 may be arranged to extend through a center of the generally circular base 14 so the flange 12 of the quick-release sealing device is axisymmetric with respect to the longitudinal axis 200. The raised neck 16 may extend a pre-determined distance from the base 14 to provide a space between a pivot element 44 and the base 14. The predetermined distance may promote ease of opening and closing of a quick-release cover 42. The raised neck 16 may be generally cylindrical to facilitate a transition from the generally circular base 14 to the raised neck 16. Further the raised neck 16 may have a wall thickness suitable for the particular application. In some embodiments, the raised neck 16 may have a flared or chamfered portion 18. The flared portion 18 may function to increase the strength of the raised neck 16 and allow for a shorter or longer raised neck. Additionally, the flared portion 18 may function to adjust the dynamic characteristics (e.g., natural frequency) of the sealing device 10 allowing for a tuned structure if the application so requires.

The flange 12 has a base thickness 20 and a base diameter 22 that may be any necessary value. The sizes of the base thickness 20 and the base diameter 22 may depend upon the particular application or particular pressure vessel flange to which the quick-release sealing device 110 is connecting. In many applications, the base thickness 20 and the base diameter 22 may be pre-determined so the flange 12 is in compliance with a particular size standard or a particular design standard, for example, the Boiler and Pressure Vessel Code, which is a publication of the American Society of Mechanical Engineers (ASME). It is preferred that the flange 12 have a base diameter 22 approximately the same, or similar to, a flange diameter of the pressure vessel flange. This may promote improved sealing between the two flanges and provide an improved connection and fit between the two flanges. The generally circular base 14 comprises a base surface 24 that may interface with a corresponding surface of the pressure vessel flange. It is preferred that the base surface be smooth, flat and substantially perpendicular with longitudinal axis 200. This may increase the seal developed at the interface between the sealing surface 24, or base surface 24, and the pressure vessel flange. If necessary, a gasket, such as a sealing gasket, for example, may be disposed between the sealing surface 24 and the pressure vessel flange to further improve the seal.

The base 14 may comprise a plurality of apertures 26. The apertures 26 may extend through the base 14 in a direction generally parallel with the longitudinal axis 200. The apertures 26 may be spaced evenly about a diameter of the base 14 with the arc length 28 between adjacent apertures being uniform about the diameter. In a preferred embodiment, the apertures 26 may align with respective apertures arranged on the pressure vessel flange. Each aperture 26 should be appropriately sized to receive an attachment element (not shown), such as a screw, a bolt, a threaded pin, a clamp, a band or any combination thereof. The attachment element may extend through the flange 14 and the pressure vessel flange to form a bolted joint. A sufficient number of attachment elements may be used to secure the flanges in a bolted configuration with sufficient mechanical integrity to withstand the loading conditions and ambient conditions the flange 12 will experience during use.

Extending from the raised neck 16 is a generally cylindrical hub 34, which in part may function to further extend the distance from the base 14 to components of the sealing device 10 that may be distal the base 14, such as a cover 42, the pivot element 44 and quick-release cover attachment elements 46. These components and others may be spaced from the base 14 to facilitate operation (i.e., articulating the cover 42 from the open position to the closed position and vice-versa) by permitting a greater range of rotation of the cover 42 as well as enhancing user access to the quick-release cover attachment elements 46. In particular, it is preferred that the pivot element 44 be spaced from the base 14. Furthermore, since the location of the pressure vessel flange on the pressure vessel may be arbitrary, positioning the cover 42 and the quick-release cover attachment elements 46 away from the base 14 may be beneficial.

In some embodiments, the flange 12 and the hub 34 may be cast or fabricated as a single, monolithic structure. A monolithic structure has the advantage of being a single piece and having no mechanical connection, such as a welded joint, that may fail or fatigue over the life of the component.

As illustrated in FIGS. 1 through 3, the flange 12 and the hub 34 may be separate pieces that are mechanically connected (e.g., by a weld) at an interface 31 between a second end 38 of the hub 34 and a receiving surface 30 of the raised neck 16. The receiving surface 30 of the raised neck 16 and the second end 38 of the hub 34 may each have a bevel 32, 40 respectively. The bevels 32, 40 may increase the effectiveness of the mechanical connection surface between the receiving surface 30 of the raised neck 16 and the second end 38 of the hub 34. If a weld is used to mechanically connect the flange 12 with the hub 34, the welded joint should be sufficient to meet all design requirements and all welding requirements.

The cover 42 interfaces with the hub 34 at a first end 36 of the hub 34. The cover 42 is mounted such that it can be articulated from an open position to a closed position (as illustrated) and from a closed position to an open position with minimum effort. The cover 42 is mounted to the hub via a frame that permits the cover 42 to rotate relative to the hub 34. The frame includes frame elements 58, 60 and a pivot element 44. The frame elements 58, 60 are rigidly connected to the hub 34 and the cover 42, respectively. The pivot element 44 is positioned relative to the frame members 58, 60 as well as supported by the frame members 58, 60 such that the cover 42 may pivot about a pivot axis 45. Illustrated is but one configuration of many configurations that will permit articulation of the cover 42 relative to the hub 34 and it is not intended that this embodiment be limited to this configuration.

The cover 42 further includes a plurality of quick-release cover attachment elements 46 that function to secure the cover 42 to the hub 34 in an operating position while at the same time maintaining a seal between the cover 42 and hub 34. One example of such a quick-release cover attachment element 46, generally referred to in the art as a “T-bolt” quick-release cover attachment element, is depicted in FIGS. 1-3, and a more detailed description of this element may be found at U.S. Pat. No. 3,187,929 to Shaw. The “operating position” is understood to mean that the interface 31 between the cover 42 and hub 34 will be sealed. The quick-release cover attachment elements 46 are arranged intermittently around the circumference of the hub 34, with each quick-release cover attachment element 46 having a trunion tube 52 that is rigidly attached to the hub 34. The quick-release cover attachment element 46 enables the cover 42 to be opened or closed in a more efficient manner by reducing the number of quick-release cover attachment elements 46 the user will need to disengage or engage. For example, there may be as many as 24 attachment elements securing a flat plate cover to the pressure vessel flange that would require removal to gain access to the interior of the pressure vessel. However, with the sealing device 10 having a quick-release cover, there may be as few as four quick-release cover attachment elements 46 to disengage to gain access to the interior of the pressure vessel. As illustrated, each quick-release cover attachment element 46 comprises a rigid link 48 having a trunion rod 56 arranged near one end and a nut 50 arranged near an opposite end. The trunion rod 56 is supported by a trunion tube 52 and the trunion tube 52 is able to rotate relative to the trunion tube 52. The quick-release cover attachment element 46 may be disengaged by loosening the nut 50. With the nut 50 loosened, the rigid link 48 may be rotated away from the cover 42 to disengage the nut 50 from the lug 54. With each nut 50 disengaged from each lug 54, the cover 42 is free to pivot about pivot axis 45 and the cover may rotate from the closed position to the open position. To reengage the quick-release cover attachment element 46, each rigid link is rotated to engage with the respective lug 54 and the respective nut 50 is tightened to an appropriate torque.

Refer now to FIGS. 4 through 7, which illustrate different perspectives of an alternate embodiment of a sealing device 110. Many of the components of the sealing device 110 are similar to the sealing device 10 illustrated in FIGS. 1 through 3; however, the entirety of the sealing device 110 will be discussed for completeness.

The sealing device 110 may comprise a generally circular flange 112 configured to interface with the pressure vessel flange (not shown) of the pressure vessel. The generally circular flange 112 may have a generally circular base 114. The generally circular base 114 provides a point of attachment to the pressure vessel flange as well as an interface to the pressure vessel flange. The flange 112 may also include a raised neck 116, which extends away from the generally circular base 114 and in a direction parallel with a longitudinal axis 202. The longitudinal axis 202 may be arranged to extend through a center of the generally circular base 114 so the flange 112 of the quick-release sealing device is axisymmetric with respect to the longitudinal axis 202. The raised neck 116 may extend a pre-determined distance from the base 114 to provide a space between a pivot element 146 and the generally circular base 114. The raised neck 116 may be generally cylindrical to facilitate a transition from the generally circular base 114 to the raised neck 116. Further the raised neck 116 may have a wall thickness suitable for the particular application. In some embodiments, the raised neck 116 may have a flared or chamfered portion (see 18, FIGS. 1 and 2).

The flange 112 has a base thickness 120 and a base diameter 122 that may be any appropriate or necessary value. The sizes of the base thickness 120 and the base diameter 122 may depend upon the particular application or particular pressure vessel flange to which the quick-release sealing device 110 is connecting. In many applications, the base diameter 122 and base thickness 120 may be pre-determined so the flange 112 is in compliance with a particular size standard or a particular design standard, for example, the Boiler and Pressure Vessel Code, which is a publication of the American Society of Mechanical Engineers (ASME). It is preferred that the flange 112 have a base diameter 122 approximately the same, or similar to, a flange diameter of the pressure vessel flange. This may promote improved sealing between the two flanges and provide an improved connection and fit between the two flanges. The generally circular base 114 comprises a base surface 124 that may interface with a corresponding surface of the pressure vessel flange. It is preferred that the base surface be smooth, flat and substantially perpendicular with the longitudinal axis 202. This may increase the seal developed at the interface between the sealing surface 124 and the pressure vessel flange. If necessary, a sealing gasket may be disposed between the sealing surface 124, or base surface 124, and the pressure vessel flange to further improve the seal.

The generally circular base 114 may comprise a plurality of apertures 126. The apertures 126 may extend through the base 114 in a direction generally parallel with the longitudinal axis 200. Apertures 126 may be spaced evenly about a diameter of the base 114 with the arc length 128 between adjacent apertures being substantially uniform about the diameter. In a preferred embodiment, the apertures 126 may align with respective apertures arranged on the pressure vessel flange. Each aperture 126 should be appropriately sized to receive an attachment element (not shown), such as a screw, a bolt, a threaded pin, a clamp, a band or any combination thereof. The attachment element may extend through the flange 114 and the pressure vessel flange to form a bolted joint. A sufficient number of attachment elements may be used to secure the flanges in a bolted configuration to withstand the loading conditions and ambient conditions the flange 112 will experience during use.

Extending from the raised neck 116 is a generally cylindrical hub 134, which in part may function to further extend the distance from the base 114 to components of the sealing device 110 that may be distal the base 14, such as a cover 142, the pivot element 146 and quick-release cover attachment elements 144. These components and others may be spaced from the base 114 to facilitate operation (i.e., articulating the cover 142 from the open position to the closed position and vice-versa) by permitting a greater range of rotation of the cover 142 as well as enhancing user access to the quick-release cover attachment elements 144. In particular, it is preferred that the pivot element 146 be spaced from the base 114. Furthermore, since the location of the pressure vessel flange on the pressure vessel may be arbitrary, positioning the cover 142, the pivot element 146 and the quick-release cover attachment elements 144 away from the base 114 may be beneficial for improved access.

In some embodiments, the flange 112 and the hub 134 may be cast or fabricated as a single, monolithic structure. A monolithic structure has the advantage of being a single piece and having no mechanical connection, such as a welded joint, that may fail or fatigue over the life of the component.

As illustrated in FIGS. 4 through 7, the flange 112 and the hub 134 may be separate pieces that are mechanically connected at an interface 131 between a second end 138 of the hub 134 and a receiving surface 30 of the raised neck 16. The receiving surface 130 of the raised neck 116 and the second end 138 of the hub 134 may have a bevel 132, 140 respectively. The bevels 132, 140 may increase the effectiveness of the mechanical connection between the receiving surface 130 of the raised neck 116 and the second end 138 of the hub 134. If a weld is used to mechanically connect the flange 112 with the hub 134, the welded joint should be sufficient to meet all design requirements and all welding requirements.

The cover 142 interfaces with the hub 134 at a first end 136 of the hub 134. The cover 142 is mounted such that it can be articulated from the open position to the closed position (as illustrated) and from the closed position to the open position with minimum effort. The cover 142 is mounted to the hub via a frame that permits the cover 142 to rotate relative to the hub 134. The frame includes frame elements 148, 150 and a pivot element 146. The frame elements 148, 150 are rigidly connected to the hub 134 and the cover 142, respectively. In particular, a plate 152 connects frame element 148 to the hub 134. The pivot element 146 is positioned relative to the frame members 148, 150 as well as supported by the frame members 148, 150, such that the cover 142 may pivot about a pivot axis 145. Illustrated is but one configuration of many configurations that will permit articulation of the cover 142 relative to the hub 134 and it is not intended that this embodiment be limited to this configuration.

The cover 142 further includes a plurality of quick-release cover attachment elements 144 that function to secure the cover 142 to the hub 134 in an operating position while at the same time maintaining a seal between the cover 142 and hub 134. FIGS. 4-7 depict another example of quick-release cover attachment element 144 generally referred to in the art as a “Double-Bolt Horizontal” quick-release cover attachment element 144 and a more detailed description of this element may be found at U.S. Pat. No. 3,077,360 to Isreal. The “operating position” is understood to mean that the interface 131 between the cover 142 and hub 134 will be sealed. The quick-release cover attachment elements 144 enable the cover 142 to be opened or closed in a more efficient manner by reducing the number of attachment elements the user will need to disengage or engage. For example, there may be as many as 24 attachment elements securing a blind flange to the pressure vessel flange that would require removal to gain access to the interior of the pressure vessel. However, with the quick-release sealing device 110 there may be as few as two quick-release cover attachment elements 144 to disengage to gain access to the interior of the pressure vessel. As illustrated, each quick-release cover attachment element 144 comprises a bolt 147 that is threaded such that two yoke halves 149 are held together to form a tight fitting clamp that seals a lower portion (not shown) and an upper portion (not shown) of the cover 142 and hub 134, respectively. The quick-release cover attachment element 144 may be disengaged by loosening the bolt 147. With the bolt 147 loosened, the yoke halves 149 may be separated and removed in order to raise or open the cover 142. With the yoke halves 149 disengaged, the cover 42 is free to pivot about pivot axis 145 and the cover 142 may rotate from the closed position to the open position. To reengage the quick-release cover attachment element 144, the yoke halves 149 are positioned relative to the lower and upper portions of the cover 142 and the hub 134. Once positioned, the bolts 147 are reengaged with the yoke halves and tightened to an appropriate torque.

The sealing device having the quick-release cover of the embodiments disclosed herein may be fabricated from any suitable material. For example, suitable materials may include carbon steels, stainless steels, aluminums, and steel alloys to name but a few. If the sealing device having the quick-release cover is to be fabricated by mechanically connecting (e.g., by welding) a flange to a hub, it is desirable that the flange and the hub be fabricated from materials that are compatible for whichever means of mechanically connecting the two components is used.

Any manufacturing technique may be used to produce the sealing device having the quick-release cover disclosed herein. For example, the sealing device having the quick-release cover may be fabricated by forging techniques, casting techniques, machining techniques, combinations of casting and machining techniques, or any suitable or appropriate manufacturing method.

It is anticipated that one use of the quick-release sealing device (i.e., the sealing device having the quick release cover) disclosed herein will be to retro-fit existing flat plate covers used to seal ports on pressure vessels or pipe-line access ports with this novel sealing device having the quick-release cover. A method of retro-fitting an existing blind flange with the quick-release sealing device may at least include the following steps.

An appropriate port on the pressure vessel for retro-fit must first be identified. The appropriate port may be a port that is in a desirable location on the pressure vessel for access purposes or may merely be a port that is available. Once the port for retro-fit is identified, the existing flat plate cover may be removed. This may include removal of a gasket or some other sealing material that is between the blind flange and the pressure vessel flange. The size of the port, the pressure vessel pressure rating and the size of the pressure vessel flange will dictate the size of the quick-release sealing device which should be used. The pressure vessel flange may be cleaned and may be machined smooth to produce a true surface if necessary and improve sealing. With the appropriate quick-release sealing device selected, the base surface (24, 124) of the quick-release sealing device may be located proximate the pressure vessel flange. Apertures of the sealing device having the quick-release cover may be aligned with apertures of the pressure vessel flange and attachment elements may be installed through the apertures. The attachment elements may be torqued to an appropriate setting and the retro-fit is complete.

When a sealing device having the retro fit quick-release cover is requested/ordered, all the required documentation (Welding Certificates, Inspection records and Testing certifications) will have been completed at an offsite facility or manufacturing facility. Thus, the quick-release sealing device may be installed on the vessel as if it was a standard blind flange. Further, the records for the welding and testing of the retro fit quick-release sealing device may be maintained on-site as required.

For the majority of applications, the retro fit quick-release sealing device will not require any welding or special equipment to be attached. Therefore, the quick-release sealing device can be installed by current maintenance personnel without any extraordinary tools or abilities. The quick-release sealing device may not require stoppage of the production line for an extended period of time, or require an ASME code certified welder to install the quick-release sealing device, which can be very costly.

The sealing device having the retro fit quick-release cover can be ordered based on the existing blind flange size (ranging from about 8 inches to about 72 inches) and current pressure ratings (ranging from about 75 pounds per square inch (PSI) to about 2500 PSI). The size and pressure rating may determine the mating flange size and bolt pattern, thereby making the application near error proof. Furthermore, a sealing device having the quick-release cover incorrectly ordered (e.g., wrong pressure rating or size) can not adapt to an incorrect flange opening. This will add an additional margin of safety to the quick-release sealing device. For example, a 150 PSI-8 inch flange has 8-Bolts whereas a 300 PSI-8 inch flange has 12-bolts.

The embodiments disclosed herein may be applicable for both “vertical” and “horizontal” applications. A vertical application is understood to mean that the sealing device having the quick-release cover accessed from the top of the pressure (i.e., the vessel is in a vertical position and the cover moves from the open position to the closed position and vice-versa by raising the cover from a horizontal position to a vertical position, or vice-versa). A horizontal application is understood to mean that the quick-release sealing device is accessed from the side of the pressure (i.e., the vessel is in a horizontal position and the cover moves from the open position to the closed position and vice-versa like a traditional door). Whether the pressure vessel is a horizontal or vertical application may impact the design of the hinges or pivot elements that allow the cover to rotate relative to the hub. Further, these retro-fit quick-open closures may be sized (standard flange size and pressure rating) for use in regions where the English system of measurement is the standard as well as regions where the metric system of measurement is the standard.

Described herein, in terms of preferred embodiments, are methodologies considered to represent the best mode of carrying out aspects of this disclosure. However, the disclosure should not be construed to be limited by the illustrated embodiments. In fact, a wide variety of additions, deletions, and modifications might well be made to the illustrated embodiments without departing from the spirit and scope of the invention as set forth in the claims.

I claim:

1. A sealing device, comprising:
a generally circular flange having a base and a raised neck, said base comprising a plurality of spaced apart apertures, each aperture for receiving an attachment element;
a generally cylindrical hub portion extending from said raised neck of said generally cylindrical flange; and
a quick-release cover for sealing a first end of said generally cylindrical hub, said quick-release cover arranged proximate said first end of said generally cylindrical hub portion,
wherein said base has a base surface substantially perpendicular to a longitudinal axis of said raised neck.

2. The sealing device of claim 1, wherein said generally cylindrical hub portion is adapted to be mechanically connected to a receiving surface of said raised neck and at a second end of said generally cylindrical hub.

3. The sealing device of claim 1, wherein said generally circular flange and said generally cylindrical hub are formed as a monolithic element.

4. The sealing device of claim 1, wherein said base surface is adapted to interface with a pressure vessel flange, said pressure vessel flange arranged at a port of a pressure vessel, each aperture spaced to align with a respective aperture of said pressure vessel flange.

5. The sealing device of claim 4, wherein said base of said flange is bolted to said pressure vessel flange with a bolt extending through each of said aligned apertures.

6. The sealing device of claim 5, wherein access to an interior of said pressure vessel is accomplished by articulation of a fewer number of quick-release cover attachment elements than a number of flat plate cover attachment bolts required to be removed.

7. The sealing device of claim 1, wherein a pivot location of said quick-release cover is spaced from said base such that said quick release cover may pivot from a closed position to an open position.

8. The sealing device of claim 7, wherein said pivot location is arranged proximate said first end of said generally cylindrical hub.

9. The sealing device of claim 4, wherein said sealing device attaches to said pressure vessel flange to retrofit an existing flat plate cover previously attached to said pressure vessel flange.

10. The sealing device of claim 1, wherein said sealing device is fabricated from a steel or a steel alloy.

11. The sealing device of claim 9, wherein a size of said sealing device is selected based on a size of said pressure vessel flange and a pressure rating of said pressure vessel.

12. The sealing device of claim 2, wherein said mechanical connection is a welded connection.

13. A method of retrofitting a flat plate cover on a port of a pressure vessel with a sealing device having quick-release cover, the method comprising:
(a) fabricating a sealing device as disclosed in claim 1;
(b) preparing a pressure vessel flange to receive said sealing device; and
(c) attaching said sealing device to said pressure vessel flange using a plurality of attachment elements.

14. The method of claim 13, further comprising the step of selecting a sealing device having an appropriate size for said pressure vessel based at least on a size of said pressure vessel flange and a pressure rating of said pressure vessel.

15. The method of claim 13, wherein said attachment elements are selected from the set of attachment elements consisting of: screws, bolts, pins, clamps, bands, threaded connectors, and any combination thereof.

16. The method of claim 13, wherein said method of retrofitting further includes removing said flat plate cover from said pressure vessel flange and replacing said flat cover with said sealing device.

17. The method of claim 13, wherein said sealing device is used in either a horizontal pressure vessel application or a vertical pressure vessel application.

18. The method of claim 13, wherein step (b) further comprises the steps of removing a sealing gasket, cleaning said pressure vessel flange and providing a replacement sealing gasket.

19. The method of claim 17, wherein a horizontal pressure vessel application may have a different pivot element configuration than a pivot element for a vertical pressure vessel application.

20. The method of claim 13, wherein said quick-release cover has a t-bolt quick-release closure.

21. The method of claim 13, wherein said quick-release cover has a double-bolt quick-release closure.
